(19) United States
(12) Patent Application Publication
(10) Pub. No.: US 2009/0255197 A1
(43) Pub. Date: Oct. 15, 2009

(54) Fenestration Products Comprising Pultrusion Reinforced Vinyl Polymer Foam

(75) Inventor: Gabriel Paul Chapman, Atlanta, GA (US)

Correspondence Address: SUTHERLAND ASBILL & BRENNAN LLP, 999 PEACHTREE STREET, N.E., ATLANTA, GA, 30309, US

(73) Assignee: GLOBAL PRODUCTS, LLC, Atlanta, GA (US)

(21) Appl. No.: 12/102,974

(22) Filed: Apr. 15, 2008

(51) Int. Cl. E06B 1/32; B32B 3/26; B32B 38/00; B32B 3/04; E06B 1/34

(52) U.S. Cl. 52/210; 428/304.4; 428/319.1; 428/319.3; 428/121; 428/122; 156/180; 52/309.9

(57) ABSTRACT

The present application provides improved fenestration products and improved methods of making fenestration products. The product may include (a) an elongated vinyl polymer foam body having a length, a first surface extending the length of the foam body, and a second surface extending the length of the foam body; and (b) an elongated fiber reinforced polymer pultrusion support engaging the foam body and substantially entirely covering the first surface, wherein at least a portion of the second surface is exposed. The method may include (a) providing an elongated vinyl polymer foam body; (b) covering a first surface extending the length of the body with an elongated fiber reinforced polymer pultrusion support; and (c) applying traditional woodworking processes to a second exposed surface extending the length of the body.

### TECHNICAL FIELD

The present application relates to fenestration products and more particularly relates to fenestration products comprising pultrusion reinforced vinyl polymer foam.

### BACKGROUND OF THE INVENTION

Generally described, it is desirable that fenestration products for the construction of doors and windows have suitable physical properties including stiffness, dimensional stability over wide ranges of temperature and humidity, non-conductivity to heat and electricity, and resistance to rot. Unfortunately, materials used to make such products may be incompatible with traditional woodworking processes such as sawing, screwing, routing, painting, and staining.

What is desired, therefore, is a fenestration product with suitable physical properties that is compatible with traditional woodworking processes. The product may be relatively strong, lightweight, and/or inexpensive, and may allow for a the construction of doors and windows that can withstand significant levels of wind pressure, as is required in many coastal communities.

### BRIEF DESCRIPTION OF THE INVENTION

The present application thus provides fenestration products and methods of making fenestration products. The product may include (a) an elongated vinyl polymer foam body having a length, a first surface extending the length of the foam body, and a second surface extending the length of the foam body; and (b) an elongated fiber reinforced polymer pultrusion support engaging the foam body and substantially entirely covering the first surface, wherein at least a portion of the second surface is exposed. The method may include (a) providing an elongated vinyl polymer foam body; (b) covering a first surface extending the length of the body with an elongated fiber reinforced polymer pultrusion support; and (c) applying traditional woodworking processes to a second exposed surface extending the length of the body.

These and other features of the present application will become apparent to one of ordinary skill in the art upon review of the following detailed description when taken in conjunction with the appended claims.

### BRIEF DESCRIPTION OF THE DRAWINGS

FIG. 1 shows a cross sectional side view of one embodiment of a fenestration product comprising a door jamb.

FIG. 2 shows a cross sectional side view of one embodiment of a fenestration product comprising an astragal.

FIG. 3 shows a raised perspective view of one embodiment of the fenestration product comprising the door jamb.

FIG. 4 shows a raised perspective view of one embodiment of the fenestration product comprising the astragal.

FIG. 5 shows a raised perspective view of one embodiment of the fenestration product comprising the door jamb.

FIG. 6 shows a raised perspective view of one embodiment of the fenestration product comprising the astragal.

### DETAILED DESCRIPTION OF THE INVENTION

Reference now will be made in detail to various aspects of this invention, including the presently preferred embodiments. Each example is provided by way of explanation of embodiments of the invention, not limitation of the invention. In fact, it will be apparent to those skilled in the art that various modifications and variations can be made in the present invention without departing from the spirit or scope of the invention. For instance, features illustrated or described as part of one embodiment can be used on another embodiment to yield a still further embodiment. Thus, it is intended that the present invention cover such modifications and variations within the scope of the appended claims and their equivalents.

Fenestration products have been developed according to aspects of this invention that include (1) an elongated vinyl polymer foam body having a length, a first surface extending the length of the foam body, and a second surface extending the length of the foam body; and (2) an elongated fiber reinforced polymer pultrusion support engaging the foam body and substantially entirely covering the first surface, wherein at least a portion of the second surface is exposed. Unlike conventional fenestration products, which may lack the strength and stiffness necessary to allow for the construction of doors and windows that can withstand significant levels of wind pressure, the instant products may be quickly installed to create doors and windows that are strong and resistant to significant levels of wind. Furthermore, because the second surface of polymer foam body is exposed, the products may be compatible with traditional woodworking processes such as sawing, screwing, routing, painting, and/or staining. Advantageously, the polymer foam may have a texture and appearance that is similar to wood, yet, unlike wood, have both resistance to rot and dimensional stability over a variety of temperatures and pressures.

### The Fenestration Product

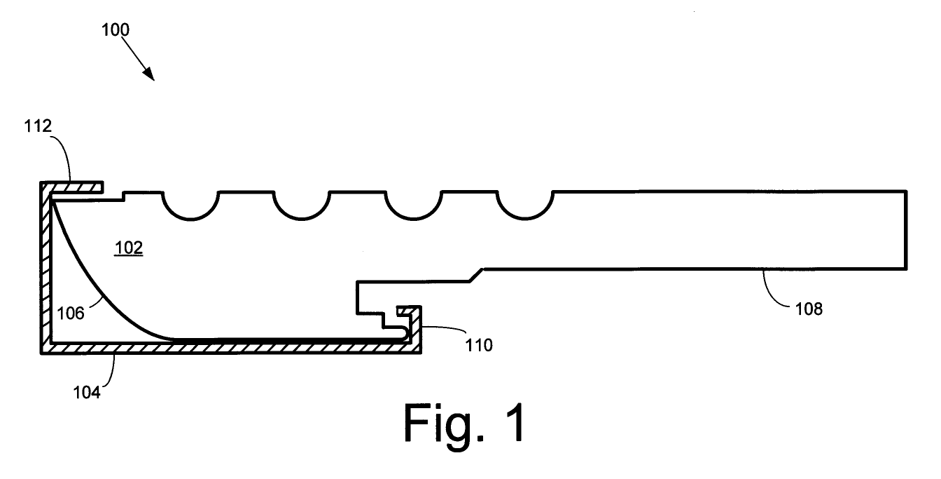

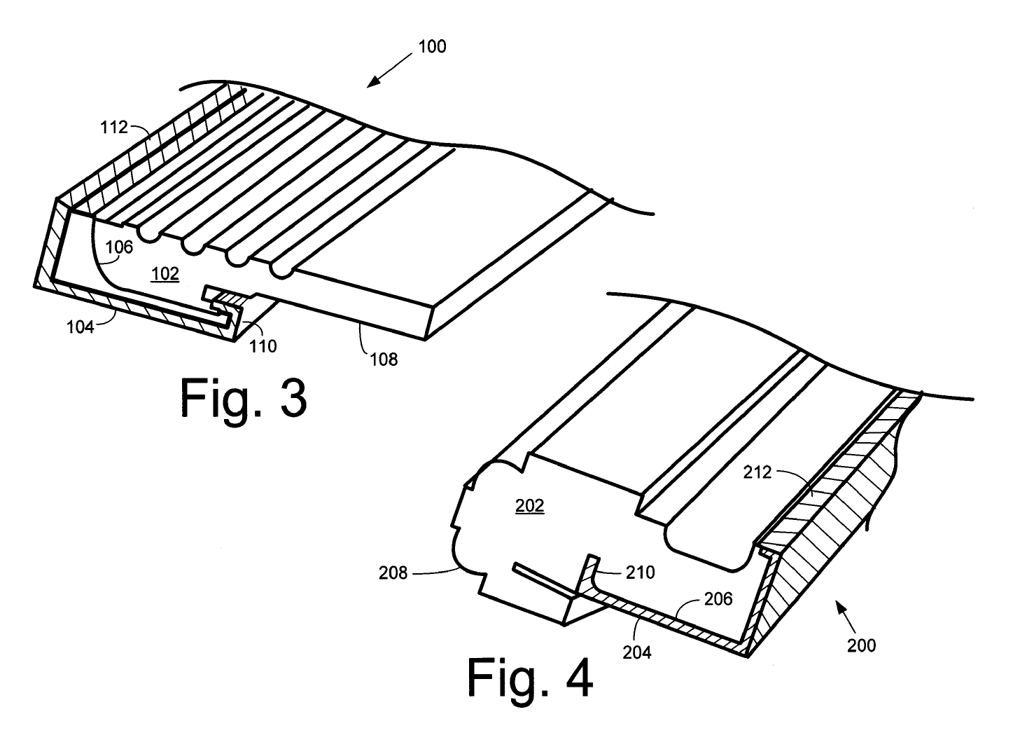

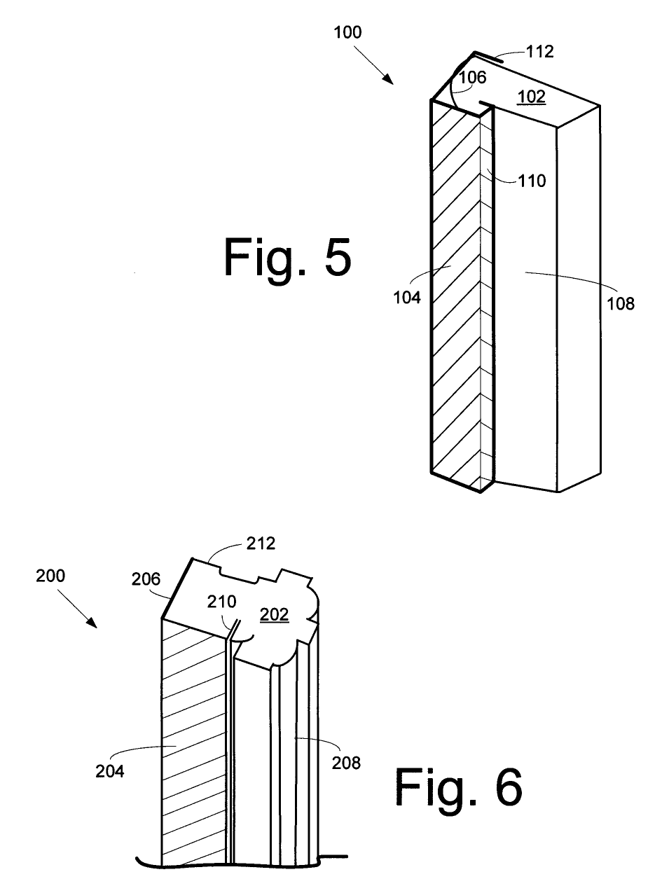

Referring now to the drawings, FIGS. 1 and 3 show a cross sectional side view and raised perspective view, respectively, of one embodiment of a fenestration product 100. The fenestration product 100 may be used as a jamb for a door.

The fenestration product 100 may include a vinyl polymer foam body 102 and a fiber reinforced polymer pultrusion support 104. The body 102 and the support 104 may be elongated in the axial direction, and may have a cross-sectional shape that is constant in the axial direction.

The body 102 may comprise any vinyl polymer foam known in the art. For example, the vinyl polymer foam may include polyethylene foam, polypropylene foam, urethane foam, polyvinyl chloride (PVC) foam, or combinations thereof. In a preferred embodiment, the vinyl polymer foam comprises PVC foam. As a result of the vinyl polymer foam, the body 102 may be light weight and compatible with traditional woodworking processes.

The support 104 may comprise any pultrusion known in the art. As used herein, the term “pultrusion” refers to composite materials of polymers and reinforcing fibers. Suitable fibers for use in the pultrusion include glass fibers, carbon fibers, silicon fibers, and combinations thereof. Suitable polymers for use in the pultrusion include thermoset plastics. In particular embodiments, the pultrusion comprises a polymer selected from the group of polyester, polyurethane, vinylester, epoxy resin, or combinations thereof. As a result of the reinforcing fibers within the pultrusion, the support 104 may be relatively stiff as compared to the body 102. As a result of the polymer within the pultrusion, the support 104 may have a relatively high strength to weight ratio.

The body 102 may have a first surface 106 that extends the length of the body 102. The support 104 may engage and substantially entirely cover or entirely cover the first surface 106. The body 102 also may have a second surface 108 that extends the length of the body 102. The second surface 108 may remain partially, substantially entirely, or entirely exposed. As a result of the support 104 covering the covering the first surface 106, the fenestration product 100 may have increased stiffness in the radial direction so that doors and windows constructed with the product 100 may be resistant to high levels of wind pressure. For example, in-swing doors constructed with the product 100 may achieve design pressure (DP) ratings of 50 or higher. As a result of the second surface 108 remaining exposed, the product 100 may be compatible with traditional woodworking processes. For example, the surface 108 may be easily painted and stained, and a door hinge may be easily mounted on the surface 108 using screws.

In a particular embodiment, the body 102 comprises a door jamb cross-sectional shape, and the support 104 comprises an L-shaped cross-sectional shape. The support 104 may further include a first lip 110 and a second lip 112. The lips 110 and 112 may allow the support 104 to only attach to the body 102 in the axial direction, and may prevent the support 104 from detaching from the body 102 in the radial direction.

The product 100 may further comprise an adhesive (not shown) between the body 102 and the support 104. The adhesive may comprise an acrylic adhesive, a urethane adhesive, an epoxy adhesive, or combinations thereof. The adhesive may have a quick curing time to allow for the quick assembly of the product 100. The adhesive also may have a level of flexibility that compensates for the different coefficients of expansion between the polymer foam body 102 and the polymer pultrusion support 104.

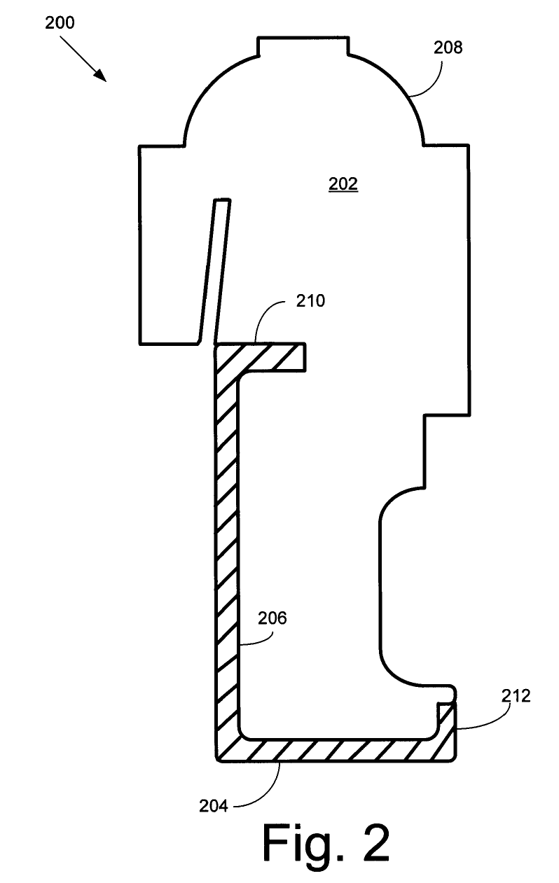

Referring again to the drawings, FIGS. 2 and 4 show a cross sectional side view and raised perspective view, respectively, of one embodiment of a fenestration product 200. The fenestration product 200 may be used as an astragal for a door.

The fenestration product 200 may include a vinyl polymer foam body 202 and a fiber reinforced polymer pultrusion support 204. The body 202 and the support 204 may be elongated in the axial direction, and may have a cross-sectional shape that is constant in the axial direction.

The body 202 may comprise any vinyl polymer foam known in the art. For example, the vinyl polymer foam may include polyethylene foam, polypropylene foam, urethane foam, polyvinyl chloride (PVC) foam, or combinations thereof. In a preferred embodiment, the vinyl polymer foam comprises PVC foam. As a result of the vinyl polymer foam, the body 202 may be light weight and compatible with traditional woodworking processes.

The support 204 may comprise any pultrusion known in the art. Suitable fibers for use in the pultrusion include glass fibers, carbon fibers, silicon fibers, and combinations thereof. Suitable polymers for use in the pultrusion include thermoset plastics. In particular embodiments, the pultrusion comprises a polymer selected from the group of polyester, polyurethane, vinylester, epoxy resin, or combinations thereof. As a result of the reinforcing fibers within the pultrusion, the support 204 may be relatively stiff as compared to the body 202. As a result of the polymer within the pultrusion, the support 204 may have a relatively high strength to weight ratio.

The body 202 may have a first surface 206 that extends the length of the body 202. The support 204 may engage and substantially entirely cover or entirely cover the first surface 206. The body 202 also may have a second surface 208 that extends the length of the body 202. The second surface 208 may remain partially, substantially entirely, or entirely exposed. As a result of the support 204 covering the covering the first surface 206, the fenestration product 200 may have increased stiffness in the radial direction so that doors and windows constructed with the product 200 may resist high levels of wind pressure. For example, in-swing doors constructed with the product 200 may achieve design pressure (DP) ratings of 50 or higher. As a result of the second surface 208 remaining exposed, the product 200 may be compatible with traditional woodworking processes. For example, the surface 208 may be easily painted and/or stained.

In a particular embodiment, the body 202 comprises an astragal cross-sectional shape, and the support 204 comprises an L-shaped cross-sectional shape. The support 204 may further include a first lip 210 and a second lip 212. The lips 210 and 212 may allow the support 204 to only attach to the body 202 in the axial direction, and may prevent the support 204 from detaching from the body 202 in the radial direction.

The product 200 may further comprise an adhesive (not shown) between the body 202 and the support 204. The adhesive may comprise an acrylic adhesive, a urethane adhesive, an epoxy adhesive, or combinations thereof. The adhesive may have a quick curing time to allow for the quick assembly of the product 200. The adhesive also may have a level of flexibility that compensates for the different coefficients of expansion between the polymer foam body 202 and the polymer pultrusion support 204.

Making the Fenestration Product

Also embodied in this invention are methods of making a fenestration product. In one embodiment, the method comprises the steps of providing an elongated vinyl polymer foam body; covering a first surface extending the length of the body with an elongated fiber reinforced polymer pultrusion support; and applying traditional woodworking processes to a second exposed surface extending the length of the body.

The step of covering the first surface may include sliding the support onto the first surface in the axial direction. Alternatively, the step of covering the first surface may include snapping the support onto the first surface in the radial direction. In a particular embodiment, the step of covering the first surface further comprises attaching the cover onto the first surface with an adhesive.

The step of applying traditional woodworking processes may include sawing, screwing, routing, painting, staining, and combinations thereof. The processes may be applied to the second surface either before or after the step of covering the first surface.

It should be understood that the foregoing relates only to the preferred embodiments of the present application and that numerous changes and modifications may be made herein without departing from the general spirit and scope of the invention as defined by the following claims and the equivalents thereof.

1. A fenestration product, comprising:
an elongated vinyl polymer foam body having a length, a first surface extending the length of the foam body, and a second surface extending the length of the foam body; and
an elongated fiber reinforced polymer pultrusion support engaging the foam body and substantially entirely covering the first surface,
wherein at least a portion of the second surface is exposed.

2. The product of claim 1, wherein substantially the entire second surface is exposed.

3. The product of claim 1, wherein the vinyl polymer comprises polyethylene, polypropylene, urethane, polyvinyl chloride, or combinations thereof.

4. The product of claim 1, wherein the support comprises glass fibers.

5. The product of claim 1, wherein the support comprises a thermoset plastic.

6. The product of claim 5, wherein the thermoset plastic comprises polyester, polyurethane, vinylester, epoxy resin, or combinations thereof.

7. The product of claim 1, further comprising an adhesive between the support and the foam body, wherein the adhesive comprises an acrylic adhesive, an epoxy adhesive, or a combination thereof.

8. (canceled)

9. The product of claim 1, wherein the body and the support have cross-sectional shapes that are constant in the axial direction.

10. The product of claim 1, wherein the body comprises a door jamb cross-sectional shape.

11. The product of claim 1, wherein the body comprises an astragal cross-sectional shape.

12. The product of claim 1, wherein the support comprises an L-shaped cross-sectional shape.

13. The product of claim 12, wherein the support comprises at least one lip.

14. The product of claim 12, wherein the support comprises two lips so that the support may only attach to the foam body in the axial direction.

15. A fenestration product, comprising:
an elongated polyvinyl chloride foam body;
a fiberglass reinforced polymer pultrusion support comprising an L-shaped cross section and engaging the foam body; and
an adhesive between the support and the body, wherein the adhesive comprises an acrylic adhesive, a urethane adhesive, an epoxy adhesive, or combinations thereof;
wherein a first surface extending the length of the body is covered by the support;
wherein a second surface extending the length of the body is exposed to accommodate traditional woodworking processes; and
wherein the L-shaped cross section comprises two lips so that the support may only attach to the body in the axial direction.

16-25. (canceled)

26. A fenestration product, comprising:
an elongated vinyl polymer foam body having a length, a first surface extending the length of the foam body, and a second surface extending the length of the foam body;
an elongated fiber reinforced polymer pultrusion support engaging the foam body and substantially entirely covering the first surface; and
an adhesive between the support and the foam body, wherein the adhesive comprises an acrylic adhesive, an epoxy adhesive, a urethane adhesive, or combinations thereof,
wherein at least a portion of the second surface is exposed.

27. The product of claim 26, wherein the vinyl polymer comprises polyethylene, polypropylene, urethane, polyvinyl chloride, or combinations thereof.

28. The product of claim 26, wherein the support comprises glass fibers.

29. The product of claim 26, wherein the support comprises a thermoset plastic.

30. The product of claim 29, wherein the thermoset plastic comprises polyester, polyurethane, vinylester, epoxy resin, or combinations thereof.

31. The product of claim 26, wherein the body and the support have cross-sectional shapes that are constant in the axial direction.
